(19) United States
(12) Patent Application Publication
(10) Pub. No.: US 2026/0231148 A1
(43) Pub. Date: Aug. 6, 2026

(54) TRANSMISSION OF MULTIPLE TRANSPORT BLOCKS SCHEDULED BY ONE DOWNLINK CONTROL INFORMATION

(71) Applicant: Nokia Technologies Oy, Espoo (FI)

(72) Inventors: Jingyuan SUN, Beijing (CN); Tzu-Chung HSIEH, Naperville, IL (US); Ping YUAN, Beijing (CN); Ping Ping WEN, Shanghai (CN)

(21) Appl. No.: 19/152,969

(22) PCT Filed: Feb. 23, 2023
(86) PCT No.: PCT/CN2023/077850

§ 371 Date: Aug. 1, 2025

(51) Int. Cl. H04W 72/1273; H04L 1/1867

(52) U.S. Cl. CPC H04W 72/1273; H04L 1/1896

(57) ABSTRACT

Various example embodiments relate to devices, methods, apparatuses and computer readable media for transmission of multiple transport blocks scheduled by one downlink control information. An example device may be configured to determine a plurality of transport blocks scheduled on respective hybrid automatic repeat request processes in accordance with one downlink control information, and transmit the plurality of transport blocks via the respective hybrid automatic repeat request processes in an order determined according to types of the hybrid automatic repeat request processes.

### TECHNICAL FIELD

Various example embodiments described herein generally relate to communication technologies, and more particularly, to devices, methods, apparatuses and computer readable media for transmission of multiple transport blocks (TBs) scheduled by one downlink control information (DCI).

### BACKGROUND

Certain abbreviations that may be found in the description and/or in the figures are herewith defined as follows:
3GPP 3rd Generation Partnership Project
CE Control Element
DCI Downlink Control Information
eMTC enhanced Machine-Type Communication
HARQ Hybrid Automatic Repeat reQuest
IoT Internet of Things
MAC Medium Access Control
NB-IoT Narrow Band Internet of Things
NTN Non-Terrestrial Network
RRC Radio Resource Control
TB Transport Block
UE User Equipment

3GPP has developed support for Internet of Things (IoT) over a Non-Terrestrial Network (NTN). In the NTN, a satellite constellation is deployed to relay communications between user equipments (UEs) and base stations (BSs) on the ground, and a distance between UE and a satellite, a distance between a satellite and the base station serving the UE may become very large, which leads to a large propagation delay and thus a long BS-UE round trip time (RTT). Since a limited number of Hybrid Automatic Repeat reQuest (HARQ) processes cannot cover the long BS-UE RTT, HARQ stalling may occur frequently.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a first device is provided. The first device may comprise at least one processor and at least one memory. The at least one memory may store instructions that, when executed by the at least one processor, cause the first device at least to determine a plurality of transport blocks scheduled on respective hybrid automatic repeat request (HARQ) processes in accordance with one downlink control information, and transmit the plurality of transport blocks via the respective HARQ processes in an order determined according to types of the HARQ processes to a second device.

In a second aspect, an example embodiment of a second device is provided. The second device may comprise at least one processor and at least one memory. The at least one memory may store instructions that, when executed by the at least one processor, cause the second device at least to receive a plurality of transport blocks via respective hybrid automatic repeat request (HARQ) processes from a first device, and decode the plurality of transport blocks. The plurality of transport blocks may be scheduled in one downlink control information and received in an order determined according to types of the HARQ processes.

In a third aspect, an example embodiment of a method is provided. The method may comprise determining at a first device a plurality of transport blocks scheduled on respective hybrid automatic repeat request (HARQ) processes in accordance with one downlink control information, and transmitting the plurality of transport blocks via the respective HARQ processes in an order determined according to types of the HARQ processes to a second device.

In a fourth aspect, an example embodiment of a method is provided. The method may comprise receiving at a second device a plurality of transport blocks via respective hybrid automatic repeat request (HARQ) processes from a first device, and decoding the plurality of transport blocks. The plurality of transport blocks may be scheduled in one downlink control information and received in an order determined according to types of the HARQ processes.

In a fifth aspect, an example embodiment of an apparatus is provided. The apparatus may comprise means for determining a plurality of transport blocks scheduled on respective hybrid automatic repeat request (HARQ) processes in accordance with one downlink control information, and means for transmitting the plurality of transport blocks via the respective HARQ processes in an order determined according to types of the HARQ processes.

In a sixth aspect, an example embodiment of an apparatus is provided. The apparatus may comprise means for receiving a plurality of transport blocks via respective hybrid automatic repeat request (HARQ) processes, and means for decoding the plurality of transport blocks. The plurality of transport blocks may be scheduled in one downlink control information and received in an order determined according to types of the HARQ processes.

In a seventh aspect, an example embodiment of a computer readable medium is provided. The computer readable medium may comprise instructions which, when executed by an apparatus, cause the apparatus at least to determine a plurality of transport blocks scheduled on respective hybrid automatic repeat request (HARQ) processes in accordance with one downlink control information, and transmit the plurality of transport blocks via the respective HARQ processes in an order determined according to types of the HARQ processes.

In an eighth aspect, an example embodiment of a computer readable medium is provided. The computer readable medium may comprise instructions which, when executed by an apparatus, cause the apparatus at least to receive a plurality of transport blocks via respective hybrid automatic repeat request (HARQ) processes, and decode the plurality of transport blocks. The plurality of transport blocks may be scheduled in one downlink control information and received in an order determined according to types of the HARQ processes.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating an example communication network in which example embodiments of the present disclosure may be implemented.

FIG. 2A is a schematic diagram illustrating downlink (DL) Hybrid Automatic Repeat reQuest (HARQ) transmission timing in Internet of Things (IoT) over Non-Terrestrial Network (NTN).

FIG. 2B is a schematic diagram illustrating uplink (UL) HARQ transmission timing in the IoT NTN.

FIG. 3 is a message flow diagram illustrating an example process according to an example embodiment of the present disclosure.

FIG. 4A is a schematic diagram illustrating an example transmission of multiple transport blocks (TBs) according to an example embodiment of the present disclosure. multiple TBs according to another example embodiment of the present disclosure.

FIG. 5A is a schematic diagram illustrating an example transmission of multiple TBs without interleaving according to an example embodiment of the present disclosure.

FIG. 5B is a schematic diagram illustrating an example transmission of multiple TBs with interleaving according to an example embodiment of the present disclosure.

FIG. 6 is a message flow diagram illustrating an example process according to an example embodiment of the present disclosure.

FIG. 7 is a schematic diagram illustrating an example DL transmission of multiple TBs according to an example embodiment of the present disclosure.

FIG. 8 is a message flow diagram illustrating an example process according to another example embodiment of the present disclosure.

FIG. 9 is a block diagram illustrating an apparatus in accordance with an example embodiment of the present disclosure.

FIG. 10 is a block diagram illustrating an apparatus in accordance with an example embodiment of the present disclosure.

FIG. 11 is a block diagram illustrating devices in a communication system in accordance with an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” may refer to a radio access network (RAN) device. The RAN device may include for example a base station that can provide cells or coverage, through which terminal devices can access the network or receive services. The base station may be implemented as an evolved node B (eNB), a next generation eNB (ng-eNB), a next generation node B (gNB), or a beyond 5G base station. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture. The base station may be deployed on the ground or in the sky, for example on a satellite, a high altitude platform station, an unmanned aircraft system, a balloon, an airplane, and/or the like.

As used herein, the term “terminal device” or “user equipment” (UE) may refer to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a D2D communication device, a V2X communication device, a sensor and the like. The term “terminal device” can be used interchangeably with a UE, a user terminal, a mobile terminal, a mobile station, or a wireless device.

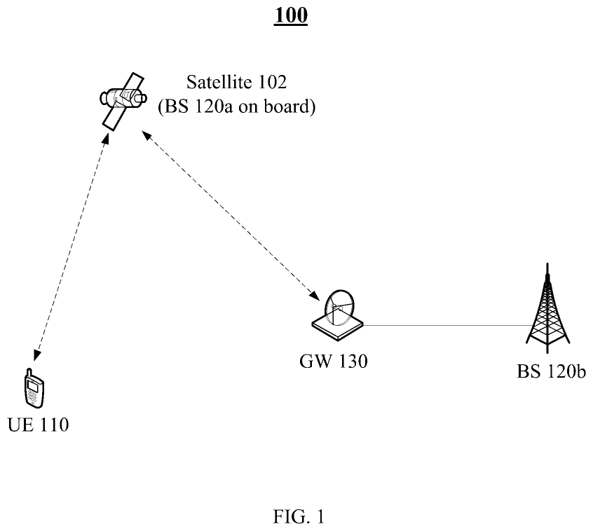

FIG. 1 is a schematic diagram illustrating an example communication network 100 in which example embodiments of the present disclosure may be implemented. The communication network 100 may form a part of a larger network e.g. a cellular communication network. Referring to FIG. 1, the communication network 100 may be implemented as a non-terrestrial network (NTN) including one or more user equipments (UEs) 110 (one is shown in FIG. 1) and one or more satellites 102 (one is shown in FIG. 1). The satellites 102 may include for example low Earth orbit (LEO) satellites, geostationary (GEO) satellites, and satellites in between GEO and LEO altitudes, or it may be replaced by e.g. an airplane, a balloon, a high altitude platform station, an unmanned aircraft system, etc.

The satellites 102 may be implemented as a regenerative satellite or a transparent satellite. The regenerative satellite may include at least part of a base station 120a to perform at least part of functionalities of the base station 120a. For example, if the satellite 102 includes a 5G New Radio (NR) base station 120 a named gNB onboard, NR-Uu radio interface may be implemented on a service link between the satellite 102 and the UEs 110, and N2/N3 interface may be implemented on a feeder link between the satellite 102 and a gateway 130 on the ground. The gateway 130 may provide interconnections to terrestrial infrastructures including for example a base station 120b and/or a core network (not shown). The transparent satellite acts as an analogue radio frequency repeater to relay communications between the UEs 110 and the base station 120b on the ground (via the gateway 130). For example, if the base station 120b is implemented as a 5G NR base station named gNB, the transparent satellite may simply repeat NR-Uu radio interface on the feeder link and the service link. Additionally, the satellites 102 may also communicate with each other via an inter satellite link (ISL). With the satellites 102, the NTN 100 can extend network services to places without any terrestrial infrastructures.

As discussed above, in the NTN 100, the UEs 110 may communicate with the base station 120a deployed on the satellite 102 or the base station 120b deployed on the ground. For convenience of description, the base station 120a and the base station 120b may be collectively referred to as base stations 120 or individually as base station 120.

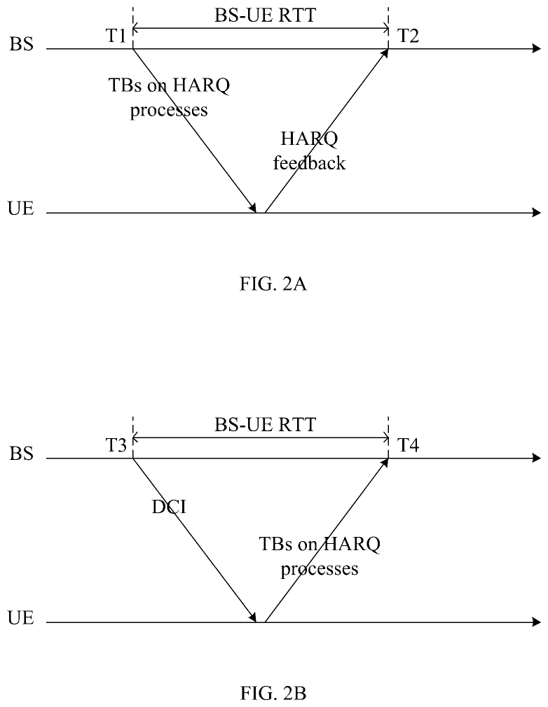

3GPP has agreed to support Internet of Things (IoT), including for example Narrow Band Internet of Things (NB-IoT) and enhanced Machine-Type Communication (eMTC), over the non-terrestrial network (NTN). Similar to the NR NTN, a Hybrid Automatic Repeat reQuest (HARQ) mechanism is also used in the IoT NTN to ensure communication reliability. FIG. 2A schematically illustrates downlink (DL) HARQ transmission timing in a non-terrestrial network (NTN). As shown in FIG. 2A, a base station (BS) may transmit transport blocks (TBs) via HARQ processes on a DL data channel to UE at time T1. The UE receives and decodes the TBs and transmits HARQ feedback (ACK or NACK) to the base station to indicate success or failure in receiving and decoding the TBs. It is assumed that the base station receives the HARQ feedback at time T2. Depending on the HARQ feedback, the base station can reuse the HARQ processes to schedule new transmissions or retransmissions. In other words, the base station cannot reuse the HARQ processes until it knows whether the previous transmissions scheduled on the HARQ processes are successful or failed. The time from T1 to T2 may be referred to as a round trip time (RTT) between the base station and the UE (hereinafter “BS-UE RTT”). Since the BS-UE RTT is long in the NTN due to the large distance between the base station and the UE, if the number of HARQ processes used for DL transmission between the base station and the UE cannot cover the long BS-UE RTT, HARQ stalling may occur frequently.

FIG. 2B schematically illustrates uplink (UL) HARQ transmission timing in the NTN. As shown in FIG. 2B, the base station transmits downlink control information (DCI) for scheduling TBs on HARQ processes to the UE at time T3. Based on the DCI, the UE transmits the TBs via the HARQ processes on an UL data channel to the base station. It is assumed that the base station receives the TBs at time T4. Depending on whether or not the base station successfully receives and decodes the TBs at T4, the base station can reuse the HARQ processes to schedule new transmissions or retransmissions. In other words, the base station cannot reuse the HARQ processes until it knows whether the previous transmissions scheduled on the HARQ processes are successful or failed. The time from T3 to T4 may also be referred to as the BS-UE RTT. Since the BS-UE RTT is long in the NTN due to the large distance between the base station and the UE, if the number of HARQ processes used for UL transmission between the base station and the UE cannot cover the long BS-UE RTT, HARQ stalling may occur frequently.

Some mechanisms have been introduced in order to mitigate impact of HARQ stalling on UE data rate. For example, a DL HARQ process may be configured as feedback enabled or disabled. If the DL HARQ process is configured as feedback enabled, the base station would not reuse the DL HARQ process for next transmission until it knows whether or not the previous transmission of the DL HARQ process is successful. If the DL HARQ process is configured as feedback disabled, the UE would not transmit HARQ feedback (ACK or NACK) for the HARQ process, and the base station can reuse the HARQ process for next transmission (new transmission or retransmission) without waiting for the HARQ feedback from the UE. Consequently, the HARQ feedback disabling can avoid HARQ stalling since the HARQ process can be reused in time.

In another example, an UL HARQ process may be configured in Mode A or Mode B. In Mode A, next transmission of the UL HARQ process would rely on a decoding result of previous transmission of the UL HARQ process. If decoding of the previous transmission is failed, the base station will schedule retransmission on the UL HARQ process. Otherwise, the base station will schedule new transmission on the UL HARQ process. In Mode B, on the contrary, the base station can reuse the UL HARQ process to schedule next transmission before availability of the previous transmission decoding result. For example, the base station can blindly schedule retransmissions on the UL HARQ process in Mode B, or no retransmission is scheduled at all. Consequently, the UL HARQ process configured in Mode B can be reused without restriction of the BS-UE RTT, and hence it can avoid HARQ stalling since the HARQ process can be reused in time.

In IoT NTN, multiple TBs may be scheduled by one DCI. In addition to resource allocation, the DCI may indicate multiple HARQ processes respectively related to the multiple TBs. In DL, the multiple HARQ processes may be independently configured as feedback enabled or disabled. Considering HARQ processes 1, 2, 3, 4 configured as feedback enabled, disabled, enabled, disabled respectively, the base station will transmit TBs on a downlink data channel in the order of the HARQ processes 1, 2, 3, 4, and the UE will transmit HARQ feedback on an uplink control channel when the HARQ process feedback is enabled, while stop HARQ feedback transmission or transmit a default value on the uplink control channel when the HARQ process feedback is disabled. In this case, the UE transmits feedback for HARQ process 1, null or default value for HARQ process 2, feedback for HARQ process 3, null or default value for HARQ process 4 in this order. As discussed above, the base station cannot reuse the HARQ processes 1, 3 configured as feedback enabled until it receives the HARQ feedback. In UL, the multiple HARQ processes may be independently configured in Mode A or B. Considering HARQ processes 1, 2, 3, 4 configured in Mode A, Mode B, Mode A, Mode B respectively, the UE will transmit TBs on an uplink data channel in the order of the HARQ processes 1, 2, 3, 4, and the base station cannot reuse the HARQ processes 1, 3 configured in Mode A for schedule of next transmission until the decoding result of the TBs received on the HARQ processes 1, 3 is available.

Example embodiments of the present disclosure provide a solution for transmission of multiple TBs scheduled by one DCI. It can reduce latency caused by HARQ stalling in case a part of HARQ processes for transmitting the multiple TBs scheduled by one DCI is configured as feedback enabled or in Mode A while a remaining part of the HARQ processes is configured as feedback disabled or in Mode B. The example embodiments can be applied to IoT NTN, including eMTC NTN and NB-IoT NTN, Long Term Evolution (LTE) NTN, NR NTN, and NR-Light NTN where multiple TBs can be scheduled by one DCI.

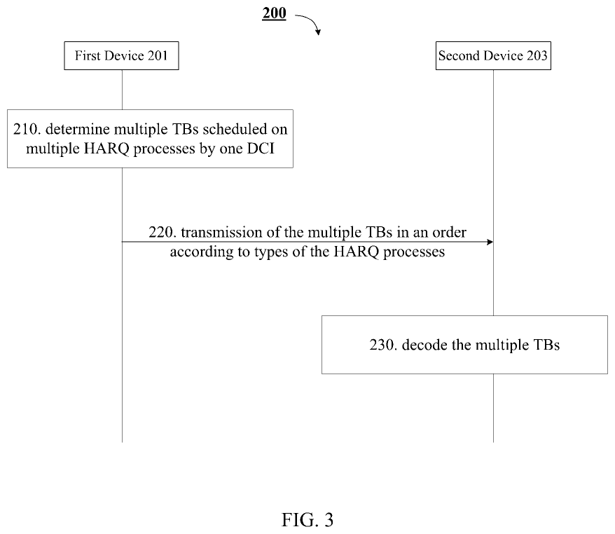

FIG. 3 is a message flow diagram illustrating an example process 200 for transmission of multiple TBs scheduled by one DCI according to an example embodiment of the present disclosure. As shown in FIG. 3, the process 200 may be performed at a first device 201 which acts as a transmitter device to transmit the multiple TBs, and a second device 203 which acts as a receiver device to receive the multiple TBs. In case the process 200 is applied to DL HARQ transmission, the first device 201 may be implemented as a network device like the base station 120 discussed above, and the second device 203 may be implemented as a terminal device like the UE 110 discussed above. In case the process 200 is applied to UL HARQ transmission, the first device 201 may be implemented as a terminal device like the UE 110 discussed above, and the second device 203 may be implemented as a network device like the base station 120 discussed above.

Referring to FIG. 3, at 210, the first device 201 may determine multiple TBs scheduled by one DCI. The DCI may be transmitted from a base station to a UE, and it may contain resource allocation for transmission of UL or DL TBs. In addition to the resource allocation, the DCI may also indicate HARQ processes on which the multiple TBs would be transmitted. In case of DL HARQ transmission, the HARQ processes may be configured as feedback enabled or feedback disabled. In case of UL HARQ transmission, the HARQ processes may be configured in Mode A or Mode B. For convenience of description, the HARQ processes configured as feedback enabled or in Mode A would be referred to as a first type of HARQ processes, and the HARQ processes configured as feedback disabled or in Mode B would be referred to as a second type of HARQ processes. The base station may semi-statically or dynamically configure the types of the HARQ processes. For example, the network may configure the types of the HARQ processes in the DCI or via a separate RRC signaling or MAC CE. As mentioned above, in case of UL HARQ transmission, the first device 201 may be implemented as the UE and it may prepare TBs to be transmitted on an UL data channel using the resources allocated by the DCI. In case of DL HARQ transmission, the first device 201 may be implemented as the base station and it may prepare TBs to be transmitted on a DL data channel using the resources indicated to the UE in the DCI.

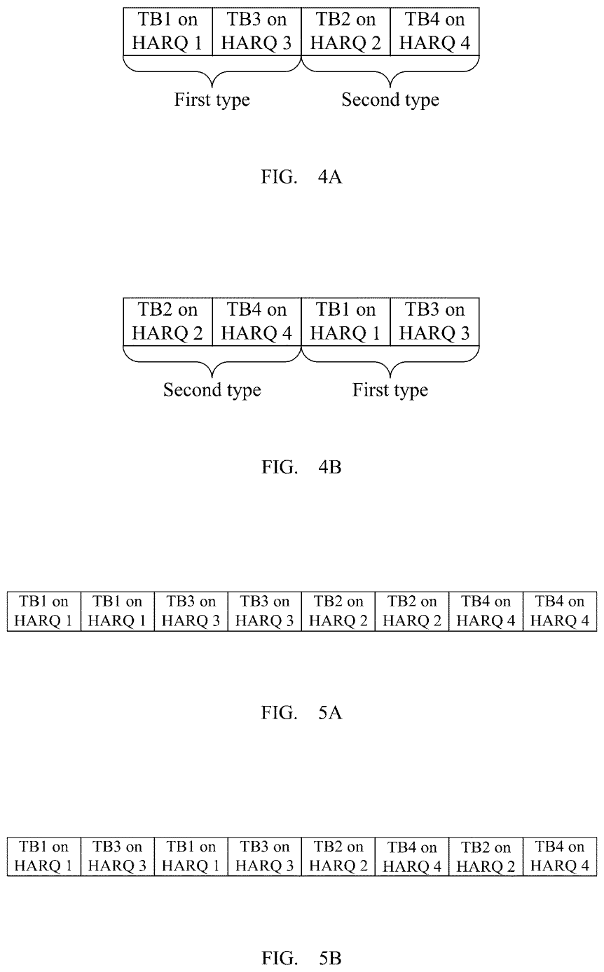

At 220, the first device 201 may transmit the multiple TBs via the respective HARQ processes in an order determined according to types of the HARQ processes. Consider an example where four TBs 1-4 are scheduled on four HARQ processes 1-4 by the DCI, the HARQ processes 1, 3 are configured as the first type (feedback enabled in case of DL HARQ or Mode A in case of UL HARQ), and the HARQ processes 2, 4 are configured as the second type (feedback disabled in case of DL HARQ or Mode B in case of UL HARQ). In the legacy processing, the TBs 1-4 would be transmitted in the order of the identities 1-4 of the HARQ processes, i.e., in the order of TB1, TB2, TB3, TB4. In the example embodiment, instead, the TBs 1-4 may be transmitted in the order of the types of the HARQ processes, despite the HARQ process identities. For example, TBs scheduled on the first type of HARQ processes may be transmitted before TBs scheduled on the second type of HARQ processes. In the example shown in FIG. 4A, the TBs 1, 3 scheduled on the HARQ processes 1, 3 of the first type are transmitted before the TBs 2, 4 scheduled on the HARQ processes 2, 4 of the second type. Accordingly, the second device 203 may receive the TBs transmitted on HARQ processes with feedback enabled or in Mode A firstly. It is beneficial for the second device 203 to proceed to a next operation earlier and hence reduce the latency caused by HARQ stalling related to the HARQ processes configured as feedback enabled or in Mode A. For example, the second device 203 may send HARQ feedback to the first device 201 earlier, or the second device 203 may reuse the HARQ processes in Mode A for schedule of next transmission earlier, so that transmission efficiency or scheduling efficiency can be improved.

In another example, TBs scheduled on the first type of HARQ processes may be transmitted after TBs scheduled on the second type of HARQ processes. In the example shown in FIG. 4B, the TBs 1, 3 scheduled on the HARQ processes 1, 3 of the first type are transmitted after the TBs 2, 4 scheduled on the HARQ processes 2, 4 of the second type. Accordingly, the second device 203 may receive the TBs transmitted on HARQ processes with feedback disabled or in Mode B firstly. In case critical data transmission is scheduled on the second type of HARQ processes, it is beneficial to transmit the second type of HARQ processes firstly because the second device 203 can receive the critical data earlier. In case fast data transmission is needed, transmission in the second type of HARQ processes can provide earlier transmission of the data without need for waiting of feedback, which can provide possibility of reuse of these HARQ processes earlier and provide fast data transmission.

In an example embodiment, the first device 201 and the second device 203 may have common understanding on the transmission order of the first and second types of the HARQ processes and follow the common understanding in transmitting and receiving the TBs at the step 220. In another example embodiment, the base station may configure the transmission order of the first and second types of the HARQ processes for the UE. For example, the base station may semi-statically configure the HARQ type transmission order via RRC signaling, or dynamically configure the HARQ type transmission order in the DCI or via MAC CE.

It would be appreciated that TBs scheduled on the HARQ processes of the same type may be transmitted in the order of the HARQ process identities. For example, as shown in FIGS. 4A and 4B, the TBs 1, 3 scheduled on the first type of HARQ processes 1, 3 may be transmitted in the order of TB1, TB3, and the TBs 2, 4 scheduled on the second type of HARQ processes 2, 4 may be transmitted in the order of TB2, TB4.

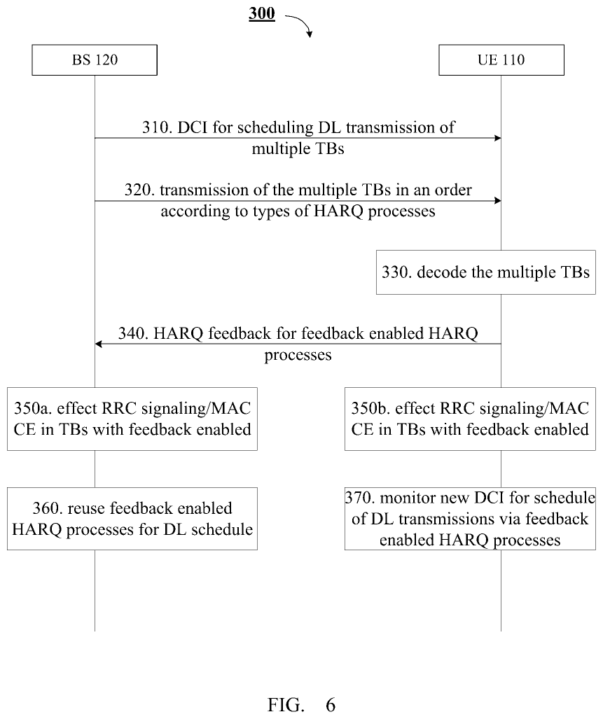

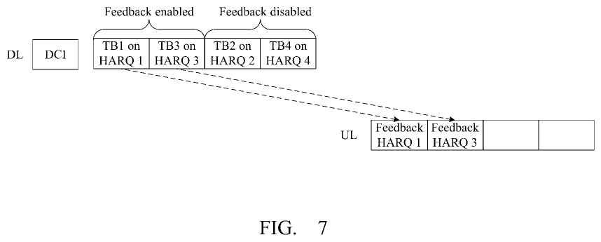

In an example embodiment, the multiple TBs may be transmitted with or without interleaving according to an interleaving configuration. The interleaving may be performed among the TBs associated with the same type of HARQ processes. Considering the example shown in FIG. 4A, it is further assumed that each TB has two repetitions. In case of without interleaving, the four TBs 1-4 may be transmitted in the order of TB1, TB1, TB3, TB3, TB2, TB2, TB4, TB4, as shown in FIG. 5A. If interleaving is configured, then the four TBs 1-4 may be transmitted in the order of TB1, TB3, TB1, TB3, TB2, TB4, TB2, TB4, as shown in FIG. 5B.

The base station may configure the interleaving for the TBs scheduled by one DCI, or for a group/set of TBs associated to HARQ processes of the same type. For example, the base station may configure TBs associated to the first type of HARQ processes with interleaving and TBs associated to the second type of HARQ processes without interleaving, or vice versa. In this way, interleaving may be flexibly configured for different types of HARQ processes. The base station may configure the interleaving in the DCI or via a separate signaling message such as RRC signaling or MAC CE.

Referring back to FIG. 3, at 230, the second device 203 may decode the TBs received at the step 220. The second device 203 may take further actions depending on the decoding result of the received TBs, which will be described below.

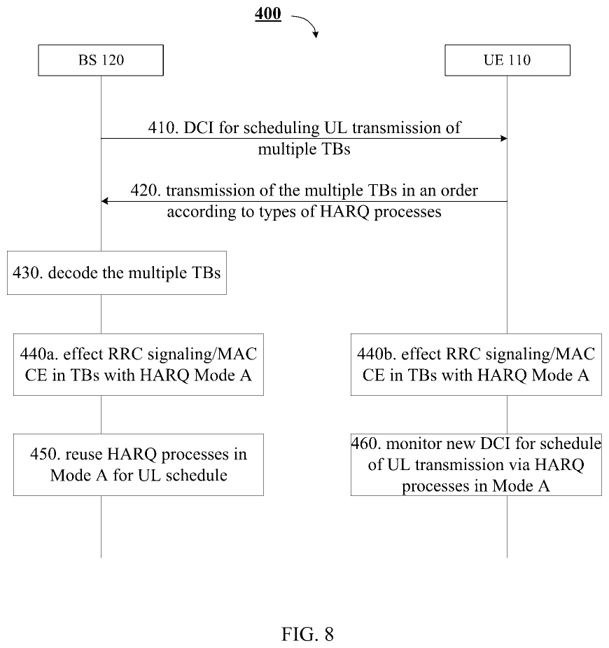

FIG. 6 is a message flow diagram illustrating an example process 300 of DL HARQ transmission according to an example embodiment of the present disclosure. The process 300 may be performed for example at the base station 120 and the UE 110. It would be appreciated some details of the process 300 have been disclosed above with respect to the process 200, and a repetitive description thereof would be omitted here.

Referring to FIG. 6, at 310, the base station 120 may send DCI for scheduling DL transmission of multiple TBs to the UE 110. The DCI may be transmitted via a DL control channel, for example physical downlink control channel (PDCCH), enhanced physical downlink control channel (EPDCCH), MTC physical downlink control channel (MPDCCH), or narrowband physical downlink control channel (NPDCCH). It may indicate frequency and time resources allocated for the UE 110 to transmit the multiple TBs on a DL data channel. The DL data channel may be for example physical downlink data shared channel (PDSCH), or narrowband physical downlink data shared channel (NPDSCH). The DCI may also indicate HARQ processes for transmission of the multiple TBs. In an example, the DCI may further configure the indicated HARQ processes as feedback enabled or feedback disabled. In another example, the HARQ processes may be configured as feedback enabled or disabled via a separate signaling message such as RRC signaling or MAC CE. For convenience of description, the HARQ processes configured as feedback enabled may also be referred to as a first type of HARQ processes, and the HARQ processes configured as feedback disabled may also be referred to as a second type of HARQ processes.

In an example embodiment, the DCI may further configure transmission of the multiple TBs with or without interleaving, which may be configured for all TBs scheduled by the DCI or for a group/set of TBs associated with a certain type of HARQ processes, e.g., TBs associated with feedback enabled HARQ processes and/or TBs associated with feedback disabled HARQ processes. The base station 120 may configure interleaving in the DCI or via a separate signaling message such as RRC signaling or MAC CE.

At 320, the base station 120 may transmit the multiple TBs via the HARQ processes in an order according to types of the HARQ processes to the UE 110. For example, as discussed above with reference to FIGS. 4A and 4B, TBs scheduled on the feedback enabled HARQ processes may be transmitted before TBs scheduled on the feedback disabled HARQ processes, or vice versa. In an example embodiment, the base station 120 and the UE 110 may have common understanding on the transmission order according to types of the HARQ processes. In another example embodiment, the base station 120 may dynamically configure the transmission order according to types of the HARQ processes for the UE 110 in the DCI or via MAC CE, or semi-statically configure the transmission order according to types of the HARQ processes for the UE 110 via RRC signaling.

In an example embodiment, the TBs may be transmitted with or without interleaving. As discussed above with reference to FIGS. 5A and 5B, the interleaving may be performed among the TBs associated with the same type of HARQ processes. The interleaving may be configured for all the TBs scheduled by the DCI or for a group/set of TBs associated to a certain type of HARQ processes. The base station 120 may configure interleaving for the TBs in the DCI or via a separate RRS signaling or MAC CE.

At 330, the UE 110 may decode the TBs received at the step 320.

At 340, the UE 110 may transmit HARQ feedback indicative of whether the TBs transmitted via the feedback enabled HARQ processes is successfully decoded to the base station 120. The HARQ feedback may be transmitted in an order determined according to the HARQ process identities. For example, referring to FIG. 7, when TB1, TB3 scheduled on HARQ processes 1, 3 with feedback enabled are transmitted before TB2, TB4 scheduled on HARQ processes 2, 4 with feedback disabled, the UE 110 may transmit feedback for HARQ process 1 and feedback for HARQ process 3 in this order. It would be appreciated that the UE 110 does not need to transmit feedback for HARQ processes 2, 4 which are configured as feedback disabled. Since TB1, TB3 scheduled on HARQ processes 1, 3 are transmitted before TB2, TB4 scheduled on HARQ processes 2, 4, the UE 110 can transmit the feedback for HARQ processes 1, 3 earlier than in the legacy scheme where the TBs are transmitted in an order according to the HARQ process identities, and hence the latency may be reduced.

In an example embodiment, the TBs transmitted via the feedback enabled HARQ processes may contain signaling messages e.g. at least one of RRC signaling or MAC CE. At 350a, the base station 120 may take the signaling messages transmitted in the DL TBs on the feedback enabled HARQ processes into effect when the base station 120 receives and successfully decodes the HARQ feedback for the TBs containing the signaling messages. For example, referring to FIG. 7, the signaling messages contained in TB1 may take effect at the base station 120 when the base station 120 successfully receives and decodes the HARQ feedback 1 indicating that TB1 is successfully decoded at the UE 110 (i.e., HARQ ACK), and the signaling messages contained in TB3 may take effect at the base station 120 when the base station 120 successfully receives and decodes the HARQ feedback 3 indicating that TB3 is successfully decoded at the UE 110 (i.e., HARQ ACK). If one signaling message is carried by TB1 and TB3 (i.e., each TB carries a part of the signaling message), the signaling message may take effect at the base station 120 when the base station 120 successfully receives and decodes both the HARQ feedback 1 and the HARQ feedback 3 indicating that TB1 and TB3 both are successfully decoded at the UE 110.

At 350b, the UE 110 may take the signaling messages received in TBs on the feedback enabled HARQ processes into effect according to the transmission time of the HARQ feedback for the TBs containing the signaling messages. For example, referring to FIG. 7, the signaling messages contained in TB1 may take effect at the UE 110 after transmission time of the HARQ feedback 1 plus an offset, and the signaling messages contained in TB3 may take effect at the UE 110 after transmission time of the HARQ feedback 3 plus the offset. If one signaling message is carried by TB1 and TB3 (i.e., each TB carries a part of the signaling message), the signaling message may take effect at the UE 110 after transmission time of the HARQ feedback for the last TB (TB3 in the example) plus the offset. The offset may be configured by the base station 120 and it may take account of a propagation delay between the UE 110 and the base station 120 and a processing delay at the base station 120. For example, the offset may be configured with a value substantially equal to half BS-UE RTT or one BS-UE RTT. With the offset, the signaling messages may take effect simultaneously at the base station 120 and the UE 110.

With continuous reference to FIG. 6, at 360, the base station 120 may reuse the feedback enabled HARQ processes for schedule of next DL transmission, in response to the HARQ feedback for the feedback enabled HARQ processes received at the step 340. For example, if the HARQ feedback for the feedback enabled HARQ process is ACK, the base station 120 may reuse the feedback enabled HARQ process for schedule of a new transmission. If the HARQ feedback for the feedback enabled HARQ process is NACK, the base station 120 may reuse the feedback enabled HARQ process for schedule of a retransmission of the TB previously transmitted on the feedback enabled HARQ process. It would be appreciated that the base station 120 may blindly schedule new transmissions or retransmissions on the feedback disabled HARQ processes since it would not receive feedback for the feedback disabled HARQ processes from the UE 110.

After the UE 110 transmits the HARQ feedback for the TBs received on the feedback enabled HARQ processes, the UE 110 may stop transmission of HARQ feedback for the other TBs received on the feedback disabled HARQ processes. For example, referring to FIG. 7, after the UE 110 transmits the HARQ feedback 1 for TB1 received on the HARQ process 1 and the HARQ feedback 3 for TB3 received on the HARQ process 3, the UE 110 would stop transmission of HARQ feedback for TB2 received on the HARQ process 2 and TB4 received on the HARQ process 4. Then at 370, the UE 110 may monitor new DCI for schedule of subsequent transmission reusing the feedback enabled HARQ processes (HARQ processes 1, 3 in the example shown in FIG. 7) according to the transmission time of the HARQ feedback. For example, in the example shown in FIG. 7, the UE 110 may start monitoring DCI for schedule of subsequent transmission on the feedback enabled HARQ processes 1, 3 after the transmission time of the HARQ feedback 3 plus an offset. The offset may be configured with a value for example higher than or equal to the BS-UE RTT.

The UE 110 may also monitor DCI for schedule of subsequent transmission on the feedback disabled HARQ processes. If the UE 110 operates in a half-duplex mode, the UE 110 may switch from the UL transmission mode to the DL receiving mode after it transmits the HARQ feedback for the feedback enabled HARQ processes, and then monitor DCI for schedule of subsequent transmission on the feedback disabled HARQ processes or monitor DCI for schedule of other transmission, e.g. SIB or other HARQ processes not scheduled in the DCI scheduling the multiple TBs. The UE 110 may start monitoring DCI for schedule of subsequent transmission on the feedback disabled HARQ processes or subsequent transmission of system information blocks (SIBs) or other HARQ processes not scheduled in the DCI scheduling the multiple TBs, according to the transmission time of the HARQ feedback. For example, in the example shown in FIG. 7, the UE 110 may start monitoring DCI for schedule of subsequent transmission on the feedback disabled HARQ processes 2, 4, or subsequent transmission of SIBs or other HARQ processes than the HARQ processes 1-4, after the transmission time of the HARQ feedback 3 plus an offset. The offset may be configured with a value taking account of an UL-DL switching delay. Since the feedback enabled HARQ processes are received before the feedback disabled HARQ processes and hence the HARQ feedback for the feedback enabled HARQ processes are transmitted earlier than in the legacy process, the UE 110 may switch to the DL receiving mode and monitor DCI for the feedback disabled HARQ processes earlier then in the legacy process. If the UE 110 operates in a full-duplex mode, the UE 110 may monitor DCI for the feedback disabled HARQ processes and for transmissions of SIBs and other HARQ processes not scheduled in the DCI scheduling the multiple TBs at any time.

FIG. 8 is a message flow diagram illustrating an example process 400 of UL HARQ transmission according to an example embodiment of the present disclosure. The process 400 may be performed for example at the base station 120 and the UE 110. It would be appreciated some details of the process 400 have been disclosed above with respect to the processes 200 and 300, and a repetitive description thereof would be omitted here.

Referring to FIG. 8, at 410, the base station 120 may send DCI for scheduling UL transmission of multiple TBs to the UE 110. The DCI may be transmitted via a DL control channel, for example PDCCH, EPDCCH, MPDCCH, or NPDCCH. It may indicate frequency and time resources allocated for the UE 110 to transmit the multiple TBs on a UL data channel. The UL data channel may be for example physical uplink data shared channel (PUSCH), or narrowband physical uplink data shared channel (NPUSCH). The DCI may also indicate HARQ processes for transmission of the multiple TBs. In an example, the DCI may further configure the indicated HARQ processes in Mode A or Mode B. In another example, the HARQ processes may be configured in Mode A or Mode B via a separate signaling message such as RRC signaling or MAC CE. For convenience of description, the HARQ processes configured in Mode A may also be referred to as a first type of HARQ processes, and the HARQ processes configured in Mode B may also be referred to as a second type of HARQ processes.

In an example embodiment, the DCI may further configure transmission of the multiple TBs with or without interleaving, which may be configured for all TBs scheduled by the DCI or for a group/set of TBs associated with a certain type of HARQ processes, e.g., TBs associated with HARQ processes in Mode A and/or TBs associated with HARQ processes in Mode B. The base station 120 may configure interleaving in the DCI or via a separate signaling message such as RRC signaling or MAC CE.

At 420, the UE 110 may transmit, based on the received DCI, the multiple TBs via the HARQ processes in an order according to types of the HARQ processes to the base station 120. For example, as discussed above with reference to FIGS. 4A and 4B, TBs scheduled on the HARQ processes in Mode A may be transmitted before TBs scheduled on the HARQ processes in Mode B, or vice versa. In an example embodiment, the base station 120 and the UE 110 may have common understanding on the transmission order according to types of the HARQ processes. In another example embodiment, the base station 120 may dynamically configure the transmission order according to types of the HARQ processes for the UE 110 in the DCI or via MAC CE, or semi-statically configure the transmission order according to types of the HARQ processes for the UE 110 via RRC signaling.

In an example embodiment, the TBs may be transmitted with or without interleaving. As discussed above with reference to FIGS. 5A and 5B, the interleaving may be performed among the TBs associated with the same type of HARQ processes. The interleaving may be configured for all the TBs scheduled by the DCI or for a group/set of TBs associated to a certain type of HARQ processes. The base station 120 may configure interleaving for the TBs in the DCI or via a separate RRS signaling or MAC CE.

At 430, the base station 120 may decode the TBs received at the step 420.

In an example embodiment, the TBs transmitted via the HARQ processes in Mode A may contain signaling messages e.g. at least one of RRC signaling or MAC CE. At 440a, the base station 120 may take the signaling messages into effect when the base station 120 successfully decodes the TBs containing the signaling messages. For example, referring to FIG. 4A, the signaling messages contained in TB1 may take effect at the base station 120 when the base station 120 successfully receives and decodes the TB1, and the signaling messages contained in TB3 may take effect at the base station 120 when the base station 120 successfully receives and decodes the TB3. If one signaling message is carried by TB1 and TB3 (i.e., each TB carries a part of the signaling message), the signaling message may take effect at the base station 120 when the base station 120 successfully receives and decodes both TB1 and TB3.

At 440b, the UE 110 may take the signaling messages transmitted in TBs on the HARQ processes in Mode A into effect according to the transmission time of the TBs containing the signaling messages. For example, referring to FIG. 4A, the signaling messages contained in TB1 may take effect at the UE 110 after the transmission time of TB1 plus an offset, and the signaling messages contained in TB3 may take effect at the UE 110 after the transmission time of TB3 plus the offset. If one signaling message is carried by TB1 and TB3 (i.e., each TB carries a part of the signaling message), the signaling message may take effect at the UE 110 after the transmission time of the last TB (TB3 in the example) plus the offset. The offset may be configured by the base station 120 and it may take account of a propagation delay between the UE 110 and the base station 120 and a processing delay at the base station 120. For example, the offset may be configured with a value substantially equal to half BS-UE RTT or one BS-UE RTT. With the offset, the signaling messages may take effect simultaneously at the base station 120 and the UE 110.

With continuous reference to FIG. 8, at 450, the base station 120 may reuse the HARQ processes in Mode A for schedule of next UL transmission. For example, if the base station 120 successfully decodes the TBs received on the HARQ processes in Mode A at the step 430, the base station 120 may reuse the HARQ processes in Mode A for schedule of new transmissions. If decoding of the TBs received on the HARQ processes in Mode A is failed at the step 430, the base station 120 may reuse the HARQ processes in Mode A for schedule of retransmissions of the TBs previously scheduled on the HARQ processes in Mode A. It would be appreciated that the base station 120 may blindly schedule new transmissions or retransmissions on the HARQ processes in Mode B without depending on the decoding result of the previous transmissions on the HARQ processes in Mode B.

After the UE 110 transmits the TBs scheduled on the HARQ processes in Mode A, at 460, the UE 110 may monitor new DCI for schedule of subsequent UL transmissions reusing the HARQ processes in Mode A according to the transmission time of the TBs previously scheduled on the HARQ processes in Mode A. For example, in the example shown in FIG. 4A, the UE 110 may start monitoring DCI for schedule of subsequent transmission on the Mode A HARQ processes 1, 3 after the transmission time of the last TB (TB3 in this example) plus an offset. The offset may be configured with a value for example higher than or equal to the BS-UE RTT.

The UE 110 may also monitor DCI for schedule of subsequent UL transmissions on the HARQ processes in Mode B. If the UE 110 operates in a half-duplex mode, the UE 110 may switch from the UL transmission mode to the DL receiving mode after it transmits the TBs scheduled by the previous DCI (TBs 1-4 in the example shown in FIG. 4A), and then monitor DCI for schedule of subsequent transmissions on the HARQ processes in Mode B. For example, in the example shown in FIG. 4A, the UE 110 may start monitoring DCI for schedule of subsequent transmissions on the Mode B HARQ processes 2, 4 after the transmission time of TB4 plus an offset. The offset may be configured with a value taking account of an UL-DL switching delay. If the UE 110 operates in a full-duplex mode, the UE 110 may monitor DCI for the HARQ processes in Mode B at any time since the base station 120 may blindly schedule UL transmissions on the HARQ processes in Mode B without relying on the decoding result of TBs previously scheduled on the HARQ processes in Mode B.

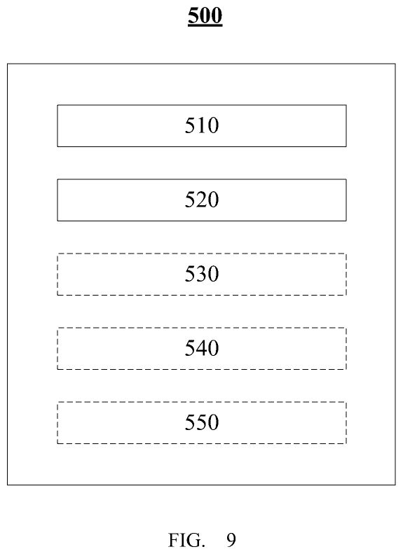

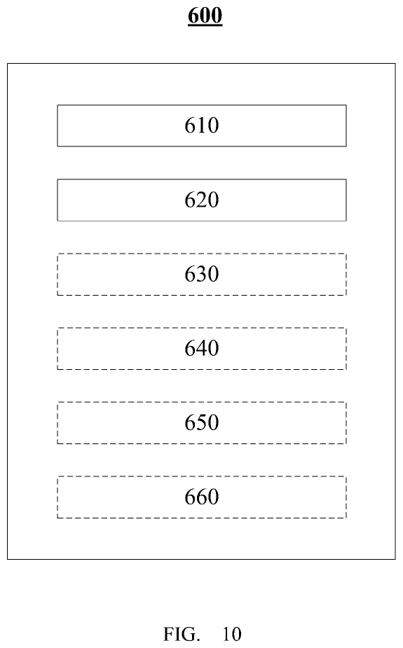

FIG. 9 is a block diagram illustrating an apparatus 500 in accordance with an example embodiment of the present disclosure. The apparatus 500 may be implemented to comprise or to form at least part of the first device 201 discussed above to perform at least part of operations related to the first device 201. As discussed above, the first device 201 may be implemented as the base station 120 to transmit DL TBs scheduled by one DCI or as the UE 110 to transmit UL TBs scheduled by one DCI. Since the operations related to the first device 201, the base station 120 and the UE 110 have been discussed above with reference to FIGS. 1-8, the blocks of the apparatus 500 will be described briefly here and details thereof may refer to the above description.

As shown in FIG. 9, the apparatus 500 may include a first means 510 for determining a plurality of transport blocks scheduled on respective hybrid automatic repeat request (HARQ) processes in accordance with one downlink control information, and a second means 520 for transmitting the plurality of transport blocks via the respective HARQ processes in an order determined according to types of the HARQ processes to a second device.

In an example embodiment, the HARQ processes may include one or more HARQ processes of a first type which are configured as feedback enabled, and one or more HARQ processes of a second type which are configured as feedback disabled.

In an example embodiment, the HARQ processes include one or more HARQ processes of a first type which are configured in Mode A, and one or more HARQ processes of a second type which are configured in Mode B.

In an example embodiment, among the plurality of transport blocks, one or more transport blocks associated with the one or more HARQ processes of the first type may be transmitted before one or more transport blocks associated with the one or more HARQ processes of the second type.

In an example embodiment, among the plurality of transport blocks, one or more transport blocks associated with the one or more HARQ processes of the first type may be transmitted after one or more transport blocks associated with the one or more HARQ processes of the second type.

In an example embodiment, the first device is a network device, and the second device is a terminal device. The apparatus 500 may further include a third means 530 for receiving, in an order determined according to identities of the one or more HARQ processes of the first type, HARQ feedback indicative of whether one or more transport blocks transmitted via the one or more HARQ processes of the first type are successfully decoded at the second device.

In an example embodiment, the first device is a terminal device, and the second device is a network device. One or more TBs transmitted on one or more HARQ processes configured in Mode A (i.e., first type) may include signaling messages of at least one of RRC signaling or MAC CE. The apparatus 500 may further include a fourth means 540 for taking the signaling messages into effect according to the transmission time of the one or more TBs transmitted on the one or more HARQ processes configured in Mode A. For example, the fourth means 540 may take the signaling messages into effect after the transmission time of the TBs containing the signaling messages plus an offset where the offset may be configured taking account of a propagation delay between the terminal device and the network device and a processing delay at the network device.

In an example embodiment, the apparatus 500 may further include a fifth means 550 for monitoring new DCI for schedule of subsequent UL transmissions reusing the HARQ processes in Mode A according to the transmission time of the TBs previously scheduled on the HARQ processes in Mode A. For example, the fifth means 550 may start monitoring DCI for schedule of subsequent transmission on the Mode A HARQ processes after the transmission time of the last TB previously scheduled on the Mode A HARQ processes (TB3 in the example shown in FIG. 4A) plus an offset. The offset may be configured with a value for example higher than or equal to the BS-UE RTT. In an example embodiment, the fifth means 550 may be also configured to monitor DCI for schedule of subsequent UL transmissions on the HARQ processes in Mode B. For example, if the terminal device operates in a half-duplex mode, the fifth means 550 may start monitoring DCI for schedule of subsequent transmissions on the Mode B HARQ processes after the transmission time of the last TB scheduled by the previous DCI (TB4 in the example shown in FIG. 4A) plus an offset where the offset may be configured with a value taking account of an UL-DL switching delay.

In an example embodiment, in a case where the plurality of transport blocks include transport blocks associated with HARQ processes of one type, the transport blocks associated with HARQ processes of one type may be transmitted in an order determined according to identities of the HARQ processes of one type.

In an example embodiment, the transport blocks associated with HARQ processes of one type may be transmitted with or without interleaving according to an interleaving configuration. The interleaving may be performed among the transport blocks associated with HARQ processes of one type.

In an example embodiment, the order of transmitting the plurality of transport blocks determined according to types of the HARQ processes may be configured via the one downlink control information, radio resource control signaling, or medium access control control element.

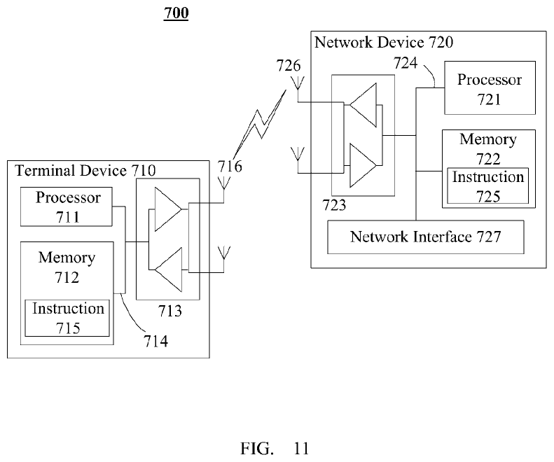

FIG. 10 is a block diagram illustrating an apparatus 600 in accordance with an example embodiment of the present disclosure. The apparatus 600 may be implemented to comprise or to form at least part of the second device 203 discussed above to perform at least part of operations related to the second device 203. As discussed above, the second device 203 may be implemented as the base station 120 to receive UL TBs scheduled by one DCI or as the UE 110 to receive DL TBs scheduled by one DCI. Since the operations related to the second device 203, the base station 120 and the UE 110 have been discussed above with reference to FIGS. 1-8, the blocks of the apparatus 600 will be described briefly here and details thereof may refer to the above description.

Referring to FIG. 10, the apparatus 600 may include a first means 610 for receiving a plurality of transport blocks via respective hybrid automatic repeat request (HARQ) processes from a first device, and a second means 620 for decoding the plurality of transport blocks. The plurality of transport blocks may be scheduled by one downlink control information and received in an order determined according to types of the HARQ processes.

In an example embodiment, the HARQ processes may include one or more HARQ processes of a first type which are configured as feedback enabled, and one or more HARQ processes of a second type which are configured as feedback disabled.

In an example embodiment, the HARQ processes may include one or more HARQ processes of a first type which are configured in Mode A, and one or more HARQ processes of a second type which are configured in Mode B.

In an example embodiment, among the plurality of transport blocks, one or more transport blocks associated with the one or more HARQ processes of the first type may be received before one or more transport blocks associated with the one or more HARQ processes of the second type.

In an example embodiment, among the plurality of transport blocks, one or more transport blocks associated with the one or more HARQ processes of the first type may be received after one or more transport blocks associated with the one or more HARQ processes of the second type.

In an example embodiment, the first device is a network device, and the second device is a terminal device. The apparatus 600 may further include a third means 630 for transmitting, in an order determined according to identities of the one or more HARQ processes of the first type, HARQ feedback indicative of whether one or more transport blocks associated with the one or more HARQ processes of the first type are successfully decoded.

In an example embodiment, the apparatus 600 may further include a fourth means 640 for monitoring a downlink control channel for subsequent transmission via the one or more HARQ processes of the first type according to the transmission time of the HARQ feedback related to the one or more HARQ processes of the first type.

In an example embodiment, the apparatus 600 may further include a fifth means 650 for monitoring a downlink control channel for subsequent transmission via the one or more HARQ processes of the second type according to the transmission time of the HARQ feedback related to the one or more HARQ processes of the first type, in a case where the second device operates in a half-duplex mode.

In an example embodiment, in a case where the one or more transport blocks associated with the one or more HARQ processes of the first type include signaling message of at least one of radio resource control signaling or medium access control control element, the apparatus 600 may further include a sixth means 660 for taking the signaling messages into effect at the second device according to the transmission time of the HARQ feedback related to the one or more HARQ processes of the first type. For example, the sixth means 660 may take the signaling messages into effect at the second device after the transmission time of the HARQ feedback related to the one or more HARQ processes of the first type plus an offset where the offset may be configured with a value taking account of a propagation delay between the first device and the second device and a processing delay at the first device.

In an example embodiment, the first device is a terminal device, and the second device is a network device.

In an example embodiment, in a case where the plurality of transport blocks include transport blocks associated with HARQ processes of one type, the transport blocks associated with HARQ processes of one type may be received in an order determined according to identities of the HARQ processes of one type.

In an example embodiment, the transport blocks associated with HARQ processes of one type may be received with or without interleaving according to an interleaving configuration. The interleaving is performed among the transport blocks associated with HARQ processes of one type.

In an example embodiment, the interleaving configuration may be configured for the plurality of transport blocks scheduled in one downlink control information or for the one type of HARQ processes.

In an example embodiment, the order of receiving the plurality of transport blocks determined according to types of the HARQ processes may be configured via the one downlink control information, radio resource control signaling, or medium access control control element.

FIG. 11 is a block diagram illustrating devices in a communication system 700 in accordance with an example embodiment of the present disclosure. As shown in FIG. 11, the communication system 700 may comprise a terminal device 710 which may be implemented as the UE 110 discussed above and a network device 720 which may be implemented as the base station 120 discussed above.

Referring to FIG. 11, the terminal device 710 may comprise one or more processors 711, one or more memories 712 and one or more transceivers 713 interconnected through one or more buses 714. The one or more buses 714 may be address, data, or control buses, and may include any interconnection mechanism such as series of lines on a motherboard or integrated circuit, fiber, optics or other optical communication equipment, and the like. Each of the one or more transceivers 713 may comprise a receiver and a transmitter, which are connected to one or more antennas 716. The terminal device 710 may wirelessly communicate with the radio access network device 720 through the one or more antennas 716. The one or more memories 712 may include instructions 715 which, when executed by the one or more processors 711, may cause the terminal device 710 to perform operations and procedures relating to the UE 110 as described above.

The network device 720 may comprise one or more processors 721, one or more memories 722, one or more transceivers 723 and one or more network interfaces 727 interconnected through one or more buses 724. The one or more buses 724 may be address, data, or control buses, and may include any interconnection mechanism such as a series of lines on a motherboard or integrated circuit, fiber, optics or other optical communication equipment, and the like. Each of the one or more transceivers 723 may comprise a receiver and a transmitter, which are connected to one or more antennas 726. The network device 720 may operate as a base station serving the terminal device 710 and wirelessly communicate with terminal device 710 through the one or more antennas 726. The one or more network interfaces 727 may provide wired or wireless communication links through which the network device 720 may communicate with other network devices, entities, elements or functions. For example, the network device 720 may communicate with a core network device (not shown) via backhaul connections. The one or more memories 722 may include instructions 725 which, when executed by the one or more processors 721, may cause the network device 720 to perform operations and procedures relating to the base station 120.

The one or more processors 711, 721 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 711, 721 may be configured to control other elements of the UE/radio access network device/core network device and operate in cooperation with them to implement the procedures discussed above.

The one or more memories 712, 722 may include at least one storage medium in various forms, such as a transitory memory and/or a non-transitory memory. The transitory memory may include, but not limited to, for example, a random access memory (RAM) or a cache. The non-transitory memory may include, but not limited to, for example, a read only memory (ROM), a hard disk, a flash memory, and the like. The term “non-transitory,” as used herein, is a limitation of the medium itself (i.e., tangible, not a signal) as opposed to a limitation on data storage persistency (e.g., RAM vs. ROM). Further, the one or more memories 712, 722 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide program instruction or instructions which, when executed by one or more processors, may cause a device or apparatus to perform the procedures described above. The program instruction for carrying out procedures of the exemplary embodiments may be written in any combination of one or more programming languages. The program instruction may be provided to one or more processors or controllers of a general purpose computer, special purpose computer, or other programmable data processing apparatus, such that the program instruction, when executed by the processor or controller, cause the functions/operations specified in the flowcharts and/or block diagrams to be implemented. The program instruction may execute entirely on a machine, partly on the machine, as a stand-alone software package, partly on the machine and partly on a remote machine or entirely on the remote machine or server.

Some exemplary embodiments further provide a computer program product or a computer readable medium having the program instruction or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A first device comprising:
at least one processor; and
at least one memory storing instructions that, when executed by the at least one processor, cause the first device at least to:
determine a plurality of transport blocks scheduled on respective hybrid automatic repeat request (HARQ) processes in accordance with one downlink control information; and
transmit to a second device, the plurality of transport blocks via the respective HARQ processes in an order determined according to types of the HARQ processes.

2. The first device of claim 1, wherein the HARQ processes include one or more HARQ processes of a first type which are configured as feedback enabled, and one or more HARQ processes of a second type which are configured as feedback disabled.

3. The first device of claim 1, wherein the HARQ processes include one or more HARQ processes of a first type which are configured in Mode A, and one or more HARQ processes of a second type which are configured in Mode B.

4. The first device of claim 2, wherein, among the plurality of transport blocks, one or more transport blocks associated with the one or more HARQ processes of the first type are transmitted before or after one or more transport blocks associated with the one or more HARQ processes of the second type.

5. The first device of claim 2, wherein the first device is a network device, and the second device is a terminal device.

6. The first device of claim 5, wherein the at least one memory further stores instructions that, when executed by the at least one processor, cause the first device at least to:
receive, in an order determined according to identities of the one or more HARQ processes of the first type, HARQ feedback indicative of whether one or more transport blocks transmitted via the one or more HARQ processes of the first type are successfully decoded at the second device.

7. The first device of claim 3, wherein the first device is a terminal device, and the second device is a network device.

8. The first device of claim 1, wherein, in a case where the plurality of transport blocks include transport blocks associated with HARQ processes of one type, the transport blocks associated with HARQ processes of one type are transmitted in an order determined according to identities of the HARQ processes of one type.

9. The first device of claim 1, wherein the transport blocks associated with HARQ processes of one type are transmitted with or without interleaving according to an interleaving configuration, where the interleaving is performed among the transport blocks associated with HARQ processes of one type.

10. The first device of claim 1, wherein the order of transmitting the plurality of transport blocks determined according to types of the HARQ processes is configured via the one downlink control information, radio resource control signaling, or medium access control control element.

11. A second device comprising:
at least one processor; and
at least one memory storing instructions that, when executed by the at least one processor, cause the second device at least to:
receive a plurality of transport blocks via respective hybrid automatic repeat request (HARQ) processes from a first device, the plurality of transport blocks being scheduled in one downlink control information and received in an order determined according to types of the HARQ processes; and
decode the plurality of transport blocks.

12. The second device of claim 11, wherein the HARQ processes include one or more HARQ processes of a first type which are configured as feedback enabled, and one or more HARQ processes of a second type which are configured as feedback disabled.

13. The second device of claim 11, wherein the HARQ processes include one or more HARQ processes of a first type which are configured in Mode A, and one or more HARQ processes of a second type which are configured in Mode B.

14. The second device of claim 13, wherein, among the plurality of transport blocks, one or more transport blocks associated with the one or more HARQ processes of the first type are received before or after one or more transport blocks associated with the one or more HARQ processes of the second type.

15. The second device of claim 12, wherein the first device is a network device, and the second device is a terminal device.

16. The second device of claim 15, wherein the at least one memory further stores instructions that, when executed by the at least one processor, cause the second device at least to:
transmit, in an order determined according to identities of the one or more HARQ processes of the first type, HARQ feedback indicative of whether one or more transport blocks associated with the one or more HARQ processes of the first type are successfully decoded.

17. The second device of claim 16, wherein the at least one memory further stores instructions that, when executed by the at least one processor, cause the second device at least to:
monitor a downlink control channel for schedule of subsequent transmission via the one or more HARQ processes of the first type according to the transmission time of the HARQ feedback related to the one or more HARQ processes of the first type.

18. The second device of claim 16, wherein the at least one memory further stores instructions that, when executed by the at least one processor, cause the second device at least to:
monitor a downlink control channel for schedule of subsequent transmission via the one or more HARQ processes of the second type according to the transmission time of the HARQ feedback related to the one or more HARQ processes of the first type, in a case where the second device operates in a half-duplex mode.

19-20. (canceled)

21. The second device of claim 11, wherein, in a case where the plurality of transport blocks include transport blocks associated with HARQ processes of one type, the transport blocks associated with HARQ processes of one type are received in an order determined according to identities of the HARQ processes of one type.

22. The second device of claim 11, wherein the transport blocks associated with HARQ processes of one type are received with or without interleaving according to an interleaving configuration, where the interleaving is performed among the transport blocks associated with HARQ processes of one type, and wherein the interleaving configuration is configured for the plurality of transport blocks scheduled in one downlink control information or for the one type of HARQ processes.

23-52. (canceled)
